(19) United States
(12) Patent Application Publication
(10) Pub. No.: US 2006/0227541 A1
(43) Pub. Date: Oct. 12, 2006

(54) Floating candle holding device and method of use

(76) Inventors: Joseph A. Reichlin JR., Reno, NV (US); Daniel Riebli, Reno, NV (US)

Correspondence Address: GREENBERG TRAURIG, 3773 HOWARD HUGHES PARKWAY, SUITE 500 NORTH, LAS VEGAS, NV, 89109, US

(21) Appl. No.: 11/104,868

(22) Filed: Apr. 12, 2005

(51) Int. Cl. F21V 35/00; F21L 19/00

(52) U.S. Cl. 362/161

(57) ABSTRACT

A floating candle holder is disclosed. The floating candle holder comprises a dish or base and a three dimensional candle support for facilitating birthday well-wishes. For instance, the floating candle holder is ideal for placing a lighted birthday candle into an alcoholic or non-alcoholic beverage as a means for presenting an individual a birthday salute. The three-dimensional candle support can take an infinite number of shapes and appearances. For example, if the recipient is a sports fan, the three-dimensional candle support may take the form of a football, basketball or baseball. The three-dimensional candle support is also ideal for carrying advertisements, logos and/or messages. Continuing with the previous example, a football-shaped three-dimensional candle support may carry the message “HAPPY BIRTHDAY.”

### FIELD OF THE INVENTION

The embodiments of the present invention relate to a floating device for holding a candle, such as a birthday candle.

### BACKGROUND

Devices for permitting lighted candles to float on a liquid are abundant in the marketplace. Such devices include plastic dishes which float while supporting a candle thereby preventing the liquid from extinguishing the candle flame. Such devices are used for decoration and are fabricated in a multitude of shapes and sizes. However, the currently available devices typically support votive candles.

Moreover, as the purpose of the current floating candle holders is primarily decorative in nature, the current floating candle holders lack many novel features which can be used to expand their marketability. For example, the current candle holders are not designed to hold conventional birthday candles. That is, conventional birthday candles (i.e., narrow cylindrical candles), unlike votive candles, need external support to maintain an upright position. For example, when used with a cake, birthday candles must be inserted into the cake so that they stand upright. In addition, while current floating candle holders comprise many different designs, they tend to be two-dimensional in nature.

Consequently, there continues to be a need for floating candle holders which support conventional birthday candles. In addition, there is a need for floating candle holders comprising unique three-dimensional designs for, among other things, depicting advertisements, logos and/or messages.

### SUMMARY

Accordingly, a first embodiment of the present invention comprises a floating candle holder for holding a birthday candle wherein the candle holder includes a base or dish, three-dimensional candle support and means for attaching the three-dimensional candle support to the dish. In a second embodiment, the three-dimensional candle support and the dish are integrally formed as one unit. In other embodiments, the candle holder does not include a base but comprises a stable floating shape of any appearance.

In either of the aforementioned embodiments and others, the three-dimensional candle support includes an elongated cavity or channel for receiving a portion of the birthday candle. Depending on the design of the three-dimensional candle support, the support may conceal only a small bottom portion of the birthday candle or may conceal a more substantial portion of the birthday candle.

Other variations, embodiments and features of the present invention will become evident from the following detailed description, drawings and claims.

### BRIEF DESCRIPTION OF THE DRAWINGS

FIG. 1 shows a perspective view of a first design of a first embodiment of the present invention;

FIG. 2 shows a perspective view of a second design of a first embodiment of the present invention;

FIG. 3 shows a perspective view of a first design of a second embodiment of the present invention; and

FIG. 4 shows the first design of the second embodiment floating in a liquid.

### DETAILED DESCRIPTION

Although the following description focuses on a birthday candle embodiment, it should be apparent that the described device is capable of being used during any type of event or celebration. In addition, the device may support candles other than birthday candles.

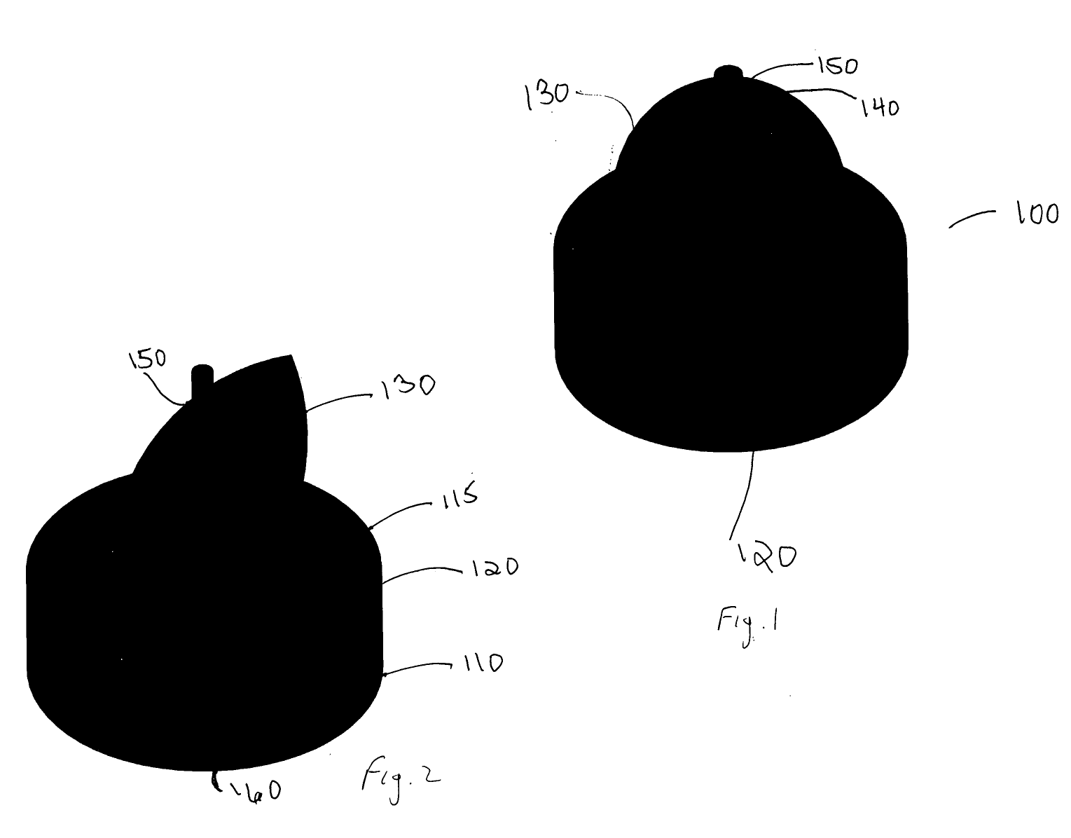

Reference is now made to the figures wherein like parts are referred to by like numerals throughout. FIG. 1 shows a first floating candle holder design of a first embodiment of the present invention generally referred to by reference numeral 100. The floating candle holder 100 comprises a base or dish 110 having a circumferential lip 120 and a three-dimensional candle support 130.

The three-dimensional candle support 130 includes an elongated cavity or channel 140 for receiving birthday candle 150. The three-dimensional candle support 130 attaches to an upper surface 115 of the dish 100 by means of a peg 160 (shown in FIG. 2) which inserts into a similarly sized cavity (not shown) in the upper surface 115 of the dish 110. This arrangement permits different three-dimensional candle supports to be interchanged with a single base. As shown in FIG. 1, and for reasons set forth below, the three-dimensional candle support 130 is shaped and fabricated to resemble a sports ball (e.g., baseball). While not shown, the three-dimensional candle support 130 can be white and include depictions of baseball laces to represent a conventional baseball. FIG. 2 shows a three-dimensional candle support 130 in the shape of a football. Again, the three-dimensional candle support 130 of FIG. 2 can include depictions of football laces. An infinite number of appearances and shapes may be used and tailored to target specific recipients. For example, baseball and football shaped three-dimensional candle supports 130 are ideal for sports fans and promoting sports teams.

As people reach adulthood, the use of a cupcake with a birthday candle loses its appeal. Consequently, there is a need for a new device for presenting adults with birthday well-wishes. The floating candle holder 100 allows friends, relatives and other individuals to present adults with well-wishes on a birthday or other occasion. For example, the floating candle holder 100 and lighted birthday candle 150 may be placed in a glass of beer such that the floating candle holder 100 floats on the beer allowing the recipient to make a wish, blow out the candle 150 and then drink the beer.

Of course, the embodiments of the present invention are also suitable for children and those who do not partake in alcohol. That is, the floating candle holder 100 is suitable for non-alcoholic beverages or any other liquids as well.

Other than an ability to develop an infinite number of designs, another benefit of using the three-dimensional candle support 130 is the ability to use a surface thereof for advertising, logo and/or message placement. In the birthday example from above, the three-dimensional candle support 130 may be used to display the message “HAPPY BIRTHDAY” or other special message (e.g., “I LOVE YOU”). Using sports as a basis for another example, the three-dimensional candle support 130 may depict professional team names and logos. Another example is premised on the placement of beer company advertisements. The possibilities are endless as they relate to using the three-dimensional candle support 130 and/or base or dish 110 as a mechanism for passing along information and/or advertising.

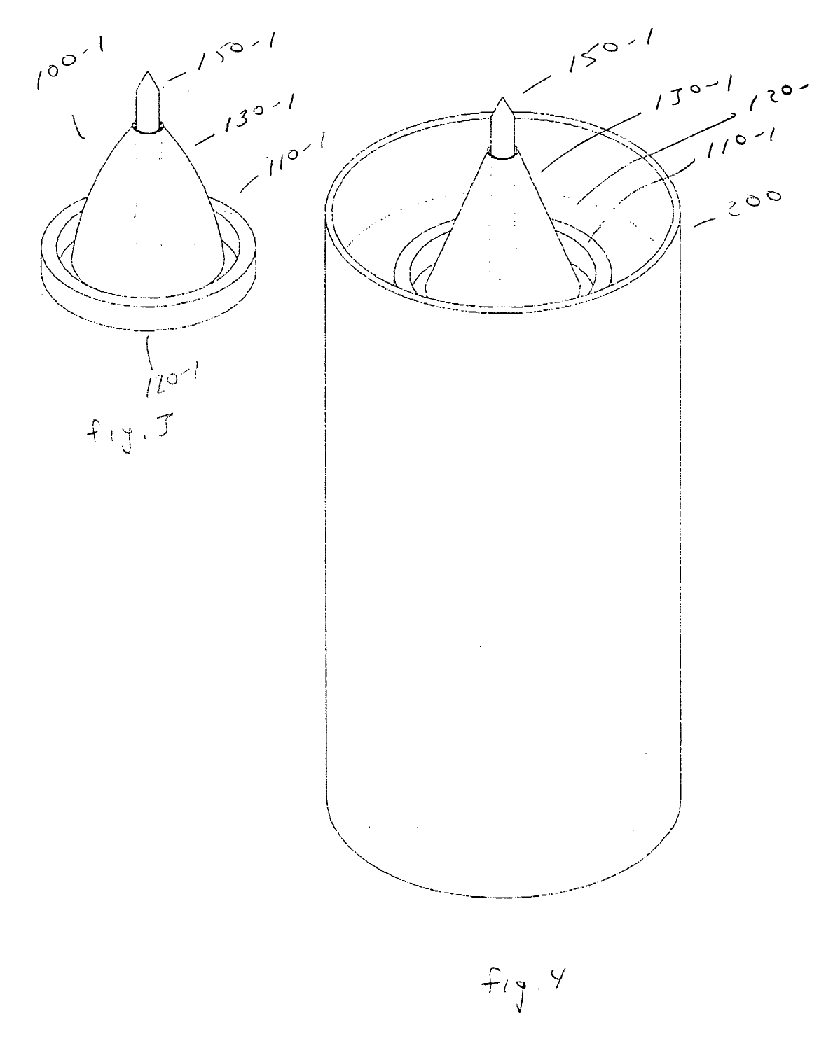

FIG. 3 shows a first design of a second embodiment wherein the three dimensional candle support 130-1 is formed integrally with the dish 110-1. In this embodiment the three-dimensional candle support 130-1 and dish 110-1 comprise a single unit. As shown, the three-dimensional candle support 130-1 is in the shape of a rounded pyramid. With this design, a majority of the candle 150-1 is concealed by the three-dimensional candle support 130-1. FIG. 4 shows the first design of the second embodiment of the floating candle holder 100-1 floating in a glass 200 of liquid (e.g., beer, milk, water or soda).

To prevent fires, the floating candle holders 100 and 100-1 should be fabricated of a non-flammable material or a material not susceptible to catching fire. While it is conceivable that the floating candle holders 100 and 100-1 may be reused, preferably they are fabricated inexpensively so as to be disposable. In addition, the size of the candle holders 100 and 100-1 should be appropriate to fit into various glasses, mugs, steins and related liquid containers.

Although the invention has been described in detail with reference to several embodiments, there are conceivably an infinite number of additional variations and modifications that exist within the scope and spirit of the invention as described and defined in the following claims.

We claim:

1. A floating candle holder comprising:
a dish, said dish including a circumferential lip; and
a three-dimensional candle support, said three dimensional candle support including an elongated cavity for receipt of a candle.

2. The floating candle holder of claim 1 wherein an outer surface of said three-dimensional candle support and/or dish depicts an advertisement, logo and/or message.

3. The floating candle holder of claim 1 wherein the candle is a birthday candle.

4. The floating candle holder of claim 3 wherein the three-dimensional candle support conceals a majority of the birthday candle.

5. The floating candle holder of claim 1 wherein the three-dimensional candle support has the appearance of a sports instrument selected from the group consisting of a football, baseball, basketball, hockey puck, tennis ball, soccer ball and golf ball.

6. The floating candle of claim 1 wherein the three-dimensional candle support is removably attached to said dish such that the dish may accommodate a plurality of different three-dimensional candle supports.

7. A floating candle holder comprising:
a base having a three-dimensional candle support, said three dimensional candle support including a channel for receipt of a candle; and
wherein the three-dimensional candle support and/or base carry an advertisement, logo and/or message.

8. The floating candle holder of claim 7 wherein the base includes a circumferential lip

9. The floating candle holder of claim 7 wherein the candle is a birthday candle.

10. The floating candle holder of claim 9 wherein the channel conceals a majority of the birthday candle.

11. The floating candle holder of claim 9 wherein the three-dimensional candle support has the appearance of a sports instrument selected from the group consisting of a football, baseball, basketball, hockey puck, tennis ball, soccer ball and golf ball.

12. The floating candle of claim 7 wherein the three-dimensional candle support is removably attached to said base such that the base may accommodate a plurality of different three-dimensional candle supports.

13. A floating candle holder comprising:
a dish, said dish including a circumferential lip;
a three-dimensional candle support, said three dimensional candle support including a channel for receipt of a birthday candle; and
wherein the three-dimensional candle support and/or dish carry an advertisement, logo and/or message.

14. The floating candle holder of claim 13 wherein the channel conceals a majority of the birthday candle.

15. The floating candle holder of claim 13 wherein the three-dimensional candle support has the appearance of a sports instrument selected from the group consisting of a football, baseball, basketball, hockey puck, tennis ball, soccer ball and golf ball.

16. The floating candle of claim 13 wherein the three-dimensional candle support is removably attached to said dish such that the dish may accommodate a plurality of different three-dimensional candle supports.

17. A floating candle holder comprising:
a dish, said dish including a circumferential lip;
a three-dimensional candle support, said three dimensional candle support including an elongated cavity for receipt of a candle; and
a candle.

18. The floating candle holder of claim 17 wherein the floating candle holder is disposable.
